(19) United States
(12) Patent Application Publication
(10) Pub. No.: US 2008/0182219 A1
(43) Pub. Date: Jul. 31, 2008

(54) Apparatus for moving a misplaced or impacted tooth

(76) Inventor: Cory J. Spalty, Hamlin, NY (US)

Correspondence Address: HOWARD J. GREENWALD P.C., 70 LINDEN OAKS, THIRD FLOOR, ROCHESTER, NY, 14625, US

(21) Appl. No.: 12/011,647

(22) Filed: Jan. 25, 2008

Related U.S. Application Data
(60) Provisional application No. 60/898,308, filed on Jan. 30, 2007.
(60) Provisional application No. 60/903,383, filed on Feb. 26, 2007.
(60) Provisional application No. 60/926,949, filed on Apr. 30, 2007.

(51) Int. Cl. A61C 7/22

(52) U.S. Cl. 433/22

(57) ABSTRACT

A self-adjusting apparatus for moving an impacted tooth, wherein said apparatus is comprised a locking mechanism, an archwire disposed within said locking mechanism, and a ligature movably connected to said locking mechanism.

### CROSS-REFERENCE TO RELATED PATENT APPLICATION

This application claims priority based upon applicant's provisional patent applications Nos. 60/898,308 (filed on Jan. 30, 2007), 60/903,383 (filed on Feb. 26, 2007), and 60/926,949 (filed on Apr. 30, 2007),

### FIELD OF THE INVENTION

An apparatus for bringing a misplaced or impacted tooth into proper alignment within a patient's mouth.

### BACKGROUND OF THE INVENTION

The prior art has addressed the problem of moving a tooth, such as an impacted canine, into an arch of teeth in a patient's mouth. As is disclosed in column 1 of U.S. Pat. No. 5,292,249 of Daniel S. German, “ . . . in the past, a force was applied to the misaligned tooth by a rubber elastic or a wire having one end affixed to the tooth and another end coupled to an arch wire which was typically mounted around the arch of teeth. The movement of the tooth was accomplished in large part by rapid movement of the tooth which occurred immediately following visits with an orthodontist who would, for example, tighten the wire. During most of the time between visits with an orthodontist the patient's misaligned tooth was not being moved towards the arch of teeth.”

The solution provided by the German patent is partially described, e.g., in claim 1 thereof, which describes: “1. An adjustable aligning reel for aligning a tooth into a predetermined position in an arch of teeth, said adjustable aligning reel comprising: an adjustable tensioner which is capable of being mounted on an archwire in operative relationship with the tooth; and a filament for coupling the tooth to said adjustable tensioner; said adjustable tensioner being adjustable to cause the filament to apply a predetermined tension to the tooth in order to maneuver the tooth towards the predetermined position; said adjustable tensioner further comprising protection means for ensuring that the predetermined tension does not exceed a preselected tension limit.” With the use of a separate “tool 70,” the patient can adjust the tension on the misaligned tooth. Thus, as is disclosed at lines 3-11 of column 3 of the German patent, “Advantageously then, the aligning reel 10 permits the orthodontist or even the patient to easily apply a predetermined amount of tension to the misaligned tooth 12. Patients can be taught to use the tool 70 (FIG. 10) to reel or winch the filament 24 in the housing 18, thereby reducing the frequency of orthodontic office visits.”

Patients are often unreliable in following their orthodontist's instructions; and, with the German device, they often will fail to make the necessary tension adjustments. It is an object of this invention to provide a self-adjusting device that will increase the tension upon a misaligned or impacted tooth during normal use of teeth by a patient.

### SUMMARY OF THE INVENTION

In accordance with this invention, there is provided a self-adjusting apparatus for moving an impacted tooth, wherein said apparatus is comprised a locking mechanism, an archwire disposed within said locking mechanism, and a ligature movably connected to said locking mechanism.

### BRIEF DESCRIPTION OF THE DRAWINGS

The invention will be described by reference to the specification and the enclosed drawings, in which like numerals refer to like elements, and wherein:

FIG. 1 is a perspective view of one preferred dental appliance disposed within the mouth of a patient;

FIG. 2 is a schematic of one preferred locking device used in the dental appliance of FIG. 1;

FIG. 3 is a schematic view of a preferred ligature connected to an orthopedic onlay;

FIG. 4 is a partial view of the ligature of FIG. 3 showing successive detent sections;

FIG. 5 is a schematic view of another preferred ligature assembly;

FIG. 6 is a partial schematic view of a ligature assembly comprised of side rails;

FIG. 7 is a bottom view of the ligature assembly of FIG. 6;

FIG. 8 is a schematic view of one preferred locking assembly that is adapted to receive the ligature assembly of FIG. 6;

FIG. 9 is a schematic illustrating the self-adjusting properties of the preferred appliance of this invention;

FIG. 10 is a perspective view of another preferred ligature assembly connected to an orthopedic onlay;

FIG. 11 is a schematic view of yet another ligature assembly movably connected to an orthopedic onlay; and

FIG. 12 is a schematic view of yet another ligature assembly.

### DESCRIPTION OF THE PREFERRED EMBODIMENTS

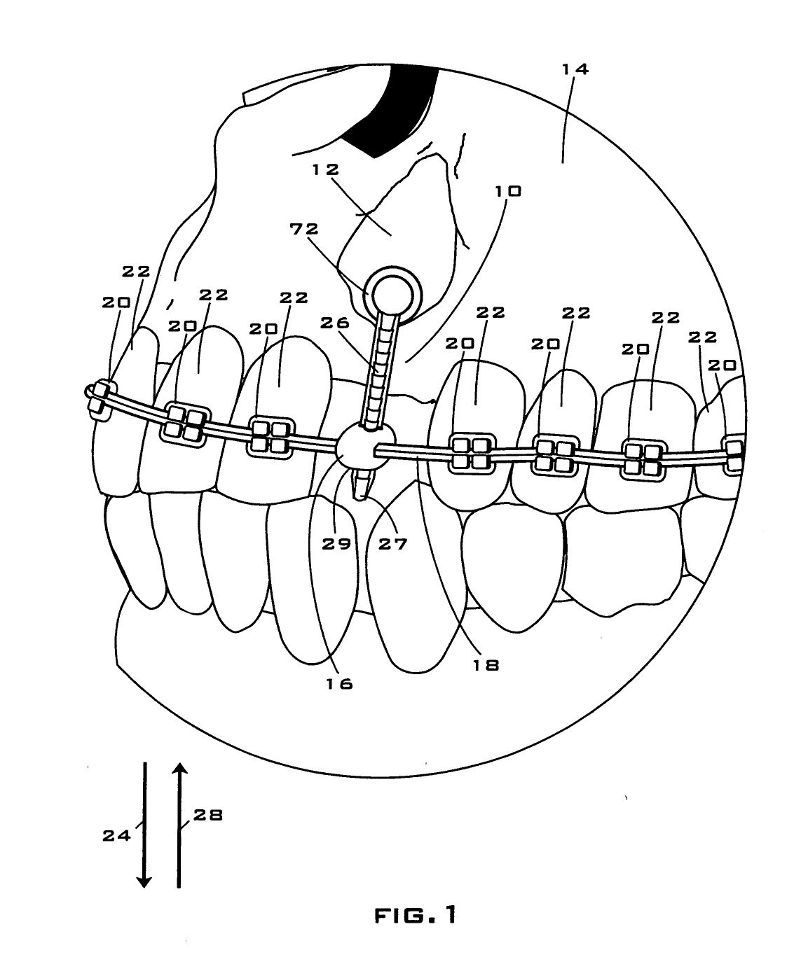

FIG. 1 is partial schematic view of an orthodontic assembly 10 that is connected to a misplaced or impacted tooth 12 within a patient's mouth 14. In the preferred embodiment depicted, the orthodontic assembly 10 is comprised of a locking mechanism 16 connected to an arch wire 18. The archwire 18, in turn, is connected via brackets 20 to teeth 22.

The locking mechanism 16 preferably provides unilateral locking, allowing movement in one direction but preventing movement in the opposite direction. In one embodiment, the locking mechanism 16 prevents rotation of the ligature within such locking mechanism due to the interaction of one or more rails on the ligature disposed within one or more slots in the locking mechanism.

Referring again to FIG. 1, when pressure is applied to locking mechanism 16 in the direction of arrow 28, ligature 26 is displaced within such locking mechanism in the direction of arrow 24 so that arch wire 18 is pulled upwardly in the direction of arrow 28. By comparison, when pressure is applied to locking mechanism 16 in the direction of arrow 24, there is no relative movement between the locking mechanism 16 and the ligature 26. Put another way, locking mechanism 16 provides unilateral locking only when force is applied in the direction of arrow 28 but not when force is applied in the direction of arrow 24.

Without wishing to be bound to any theory, applicant believes that, once the lock 16 and the arch wire 18 have been displaced in the direction of arrow 28, the archwire 18 applies a reflex force in the direction of arrow 24 thus applying an eruptive force to impacted tooth 12 and slowly drawing it down in the direction of arrow 24 and into proper alignment.

The orthodontic appliance 10 is preferably used in a process in which a locking mechanism is attached to an archwire 18. One may use any of the archwires known to those skilled in the art as archwire 18. Thus, e.g., one may use one or more of the archwires disclosed in U.S. Pat. Nos. 5,017,133 (orthodontic archwire), 5,131,843 (orthodontic archwire), 5,951,793 (Ni—Ti—Pd superelastic alloy material, its manufacturing method, and orthodontic archwire made of this alloy material), 6,036,489 (torqued titanium-based archwire), 7,244,121 (torqued titanium based archwire), and the like. The entire disclosure of each of these United States patents is hereby incorporated by reference into this specification.

Referring again to FIG. 1, and in the preferred embodiment depicted, therein, the archwire 18 is disposed within the locking device 16.

One may use many of the locking heads described in the prior art as locking device 16. Thus, by way of illustration and not limitation, one may use the locking head described in claim 1 of U.S. Pat. No. 6,484,367 of Caveney et al., the entire disclosure of which is hereby incorporated by reference into this specification. Claim 1 of this patent describes, e.g., a “ . . . a locking head including a strap accepting channel in the head that divides the locking head into a first part and a second part, the strap accepting channel having a strap entry end and a strap exit end on opposite ends of a strap accepting channel axis . . . the locking head further including a metal locking device receiving cavity adjacent to and open toward the strap exit end of the locking head and an extending wall located between the receiving cavity and the strap accepting channel . . . .”

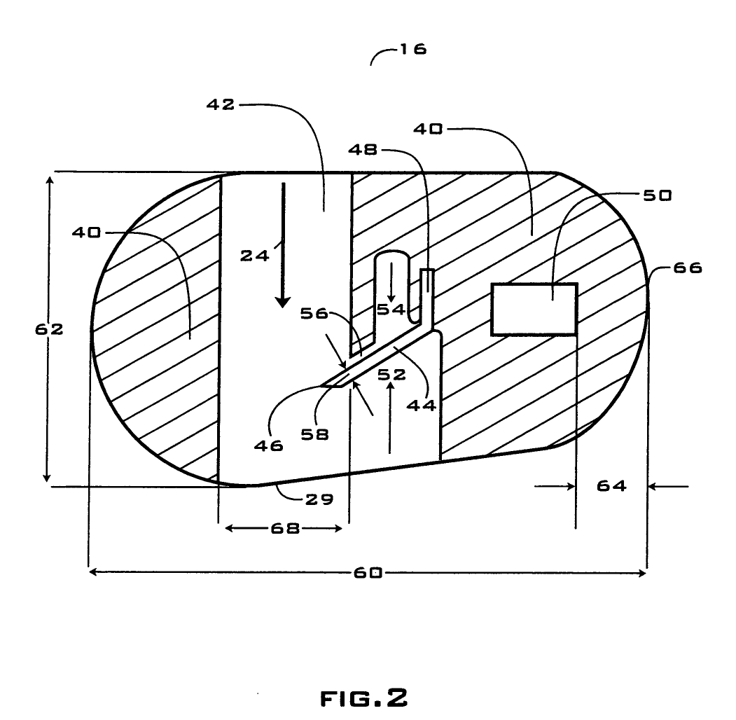

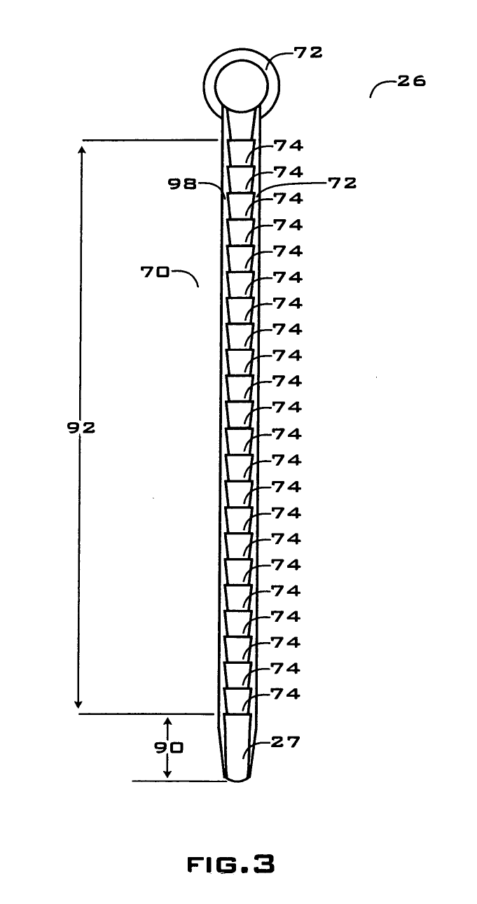

In one embodiment, illustrated in FIG. 2, the locking head described in FIG. 3 of U.S. Pat. No. 6,484,367 is produced, a hole is drilled (or molded) therein to accept an archwire 18, and such locking head is then used as the locking device 16.

FIG. 2 is similar in many respects to FIG. 3 of U.S. Pat. No. 6,484,367; and it depicts one preferred embodiment of a locking device 16 that is adapted to receive an archwire 18. Referring to FIG. 2, and to the preferred embodiment depicted therein, it will be seen that locking device 16 is preferably comprised of a body 40 that preferably is comprised of or consists essentially of plastic material. In one embodiment, the plastic material is a biocompatible plastic material such as, e.g., biocompatible nylon or biocompatible polypropylene. Reference may be had, e.g., to U.S. Pat. Nos. 3,630,205 (polypropylene monofilament sutures), 5,217,485 (polypropylene monofilament suture), 5,269,807 (suture manufactured from syndiotactic polypropylene), 5,871,502, and the like. The entire disclosure of each of these United States patents is hereby incorporated by reference into this specification.

By way of further illustration, the biocompatible plastic material may be one or more of the materials described in U.S. Pat. No. 5,378,146 (“Polyurethane biomedical devices & method of making same”), the entire disclosure of which is hereby incorporated by reference into this specification. Claim 1 of this patent describes one such suitable material, stating: “1. An orthodontic tensioning device which is subject to substantial elongation during use, said device made of an elastomeric thermoplastic polyurethane material, the outer surface of said orthodontic tensioning device having been subjected to ion implantation such that said device possesses properties of reduced protein adsorption and improved stain resistance, wherein said implanted ions are selected from the group consisting of fluoride and argon, and wherein said device retains its reduced protein adsorption and improved stain resistance properties during elongation.

In one preferred embodiment, the biocompatible plastic material is “Bioplast.” This material is well known to those in the art. Reference may be had, e.g., to U.S. Pat. Nos. 4,504,226 (method and apparatus for positioning maxillary and mandibular arch models), 4,863,733 (method of preparing treatment compositions for use in plastic or cosmetic surgery), 6,117,425 (supplemented or unsupplemented tissue sealants), 7,135,027 (devices and methods for mixing and extruding medically useful compositions), and the like. The entire disclosure of each of these United States patents is hereby incorporated by reference into this specification.

Another preferred material is a biostable polyurethane product that is described, e.g., in U.S. Pat. No. 5,254,662, the entire disclosure of which is hereby incorporated by reference into this specification.

Referring again to FIG. 2, and to the preferred embodiment illustrated therein, it will be seen that locking device 16 is comprised of a through hole 42 adapted to receive ligature 26 (see FIG. 1). In the embodiment depicted, metal locking device 44 extends into through hole 42 and interacts with the ligature 26 to unilaterally lock it within such through hole.

It is preferred to size the metal locking device 44 for a particular application to prebend it so that a free end 46 is at a predetermined angle relative to fixed end 48. In one embodiment, fixed end 48 is substantially parallel to the through hole channel 42.

In one embodiment, the body 40 is molded around the fixed portion 48 of the locking device 44. In another embodiment, illustrated in U.S. Pat. No. 6,484,367, the body 40 is molded with a channel adapted to receive a portion of such locking device 44, and the locking device is inserted into such channel after its fabrication.

One may use other metal or plastic locking devices instead of, or in addition to, the metal locking device 44. Thus, e.g., one may use the metallic barb described and claimed (in part) in U.S. Pat. No. 5,621,949 that describes, in claim 1 thereof, “ . . . an elongate barb having a first end portion embedded into said barb support surface, an intermediate portion extending from said first end portion and a second end portion opposite said first end portion extending into said passage for locking engagement with said strap . . . .” The entire disclosure of this United States patent is hereby incorporated by reference into this specification.

One may use one or more of the metal locking devices discussed in the specification of U.S. Pat. No. 6,484,367. Thus, and as is disclosed in such specification, “Plastic cable ties having metal locking device inserts are well known in the art. Examples of such include U.S. Pat. No. 3,457,598 to Mariani and U.S. Pat. No. 5,517,727 to Bernard et al. Cable ties of this type include a metal locking device partially embedded at an angle within a strap accepting channel of a cable tie head. The metal locking device is situated at an angle that allows insertion of a cable tie strap in an insertion direction, but allows for engagement of the locking device with the strap when it is pulled in a removing direction to prevent removal. The metal locking device of such conventional cable ties is in the form of a cantilevered beam that is fixed at one end and extends into the strap accepting channel at the free end.”

Such U.S. Pat. No. 6,484,367 also discloses that: “Most of such cable ties are formed using a straight section of metal as the locking device. To achieve the desired angular relationship relative to a strap insertion channel, the straight locking device must be inserted into a metal locking device receiving cavity at an angle. However, clearances to achieve such mounting are difficult due to the minimal space provided by the strap accepting channel. Moreover, achieving a proper angular relationship within such tight constraints can be difficult to achieve.”

Such U.S. Pat. No. 6,484,367 also discloses that: “An alternative solution can be found in U.S. Pat. No. 5,815,891 which provides a straight metal locking barb that is inserted into a locking barb receiving cavity parallel to the strap accepting channel. Then, once the locking barb has been mounted into a mounting surface of the head, the locking barb is mechanically bent to have an obtuse angle so that a sharpened free end of the locking barb is within the strap accepting channel. However, there are several difficulties with such a method of installation. First, the size of the cavity and locking barb are quite small. Achieving a desired bend angle within such constraints would be nearly impossible. Second, to achieve a desired bend angle requires overbending. That is the metal must be bent by a certain extra angular amount than a desired angle because upon release of the bending force the metal will slightly relax and elastically straighten out by a certain degree. Due to the provision of a stop member in the 891 patent bending may not occur beyond an angle where the locking barb abuts the stop member without possible damage to the stop member. However, due to the elasticity of the metal upon bending, the free end of the locking barb will straighten out by a certain amount after the bend. This leaves the free end of the locking barb located an undesired angular distance away from the stop member.”

It is also disclosed in U.S. Pat. No. 6,484,367 that: “Another patent U.S. Pat. No. 5,193,251 provides a different type of cable tie with a pair of bent locking barbs. The cable tie of the 251' patent is a four-piece tie that utilizes a pair of barbs within a locking head having a pair of strap passageways that allow passage of a non-integral strap for surrounding a bundle or the like. However, the patent is silent as to how the barbs are formed. The locking head does not appear to specifically include a stop member. However, to the extent that a stop member is provided, the locking barbs are spaced by a certain substantial distance above the member so as to be freely pivotal or bendable by a certain degree. The 891 patent discusses the 251 patent briefly and alleges that the barbs in the 251 patent are prebent. Nonetheless, there is no specific teaching of how such prebending could be performed, the resulting structure or any advantages to prebending. If anything, the 891 patent's teaching of bending after insertion of the locking barb into the cavity teaches against use of prebent barbs.”

Referring again to FIG. 2, and to the preferred device illustrated therein, it will be seen that locking device 16 preferably is comprised of an orifice 50 adapted to receive the archwire 18 (not shown in FIG. 2, but see FIG. 1). In embodiment illustrated in FIG. 2, the orifice 50 is rectilinear; in one aspect of this embodiment, the orifice 50 has a square cross-sectional shape; in another aspect, the orifice 50 has a rectangular cross-sectional shape. In another embodiment, the orifice 50 has a circular cross-sectional shape. In one preferred embodiment, the orifice 50 is perpendicular to the through hole 42. In another embodiment, the orifice 50 is rotated 35 degrees in another 25 degrees.

The orifice 50 may be formed during the molding operation. Alternatively, the body 40 may be formed without such orifice 50, and the orifice 50 may thereafter be drilled into it.

Referring again to FIG. 2, and in the preferred embodiment depicted, it will be seen that above and below metallic tab 44 are open spaces 52, 54, and 56 that allow the tab 44 room to flex when it is deflected as a result of pressure being applied to it by the ligature 26 (not shown) in the direction of arrow 24.

In the embodiment depicted in FIG. 2, the width of open space 56 is from about 0.01 to about 1.0 millimeter. When the narrower portion of this range is used (from about 0.1 to about 0.3 millimeters), the tab 44 will not readily disengage from detent formations 74 of ligature 26 (see FIG. 3). When, however, the broader portion of this range is used (from about 0.4 millimeters and greater), the tab 44 will disengage when a force in excess of about 60 grams is applied. As will be apparent, this is a function of, e.g., the geometry and materials used in the metal tab 44.

Referring again to FIG. 2, it will be seen that the thickness 58 of section 46 of the metal tab 44 is preferably less than about 0.008 inches. In one aspect of this embodiment, such thickness is from about 0.009 to 0.006 inches. The width of tab 44 (not shown) is preferably at least 0.02 inches and more preferably is about 0.035 inches.

In one preferred embodiment, the free end 46 of metal tab 44 preferably deflects when pressure is applied in the direction of arrow 24, provided that such pressure is at least about 20 grams. In one embodiment, the end 46 deflects upon the application of a pressure of at least about 100 grams. In another embodiment, the end 46 deflects upon the application of a pressure of at least about 300 grams.

Referring again to FIG. 2, and in the preferred embodiment depicted, it will be seen that locking device 16 has a width 60 of from about 3 millimeters to about 6 millimeters, and a height 62 of from about 2 to about 4 millimeters. The ratio of width 60 to height 62 is preferably at least 1.1/1 and, more preferably, at least 1.2/1.

In the embodiment depicted in FIG. 2, the orifice 50 is disposed at a distance 64 from edge 66 of body 40 of at least about 0.2 millimeters. In one aspect of this embodiment, distance 64 is at least about 0.5 millimeters. In one aspect of this embodiment, the length 60 is increased beyond 6 millimeters (up to about, e.g., 20 millimeters).

The width 68 of through hole 42 is preferably from about 1 to about 2 millimeters.

Referring again to FIG. 1, prior to the use of assembly 10 end 27 of ligature 26 is inserted into through hole 42. The ligature 26 may be any of the unilaterally locking ligatures known to the prior art and/or utilize one or more of the features of such prior art ligatures.

In one preferred embodiment, the ligature 26 is comprised of successive detent formations. Referring to FIG. 3, which is schematic view of one preferred ligature 26, it will be seen that such ligature is comprised of tapered end 27, intermediate locking portion 70, and orthopedic onlay 72.

Referring to such FIG. 3, it will be seen that the ligature 26 is comprised a series of successive detent formations 74 disposed along an outer surface of the shaft. In that respect, this ligature is somewhat similar to the ligature disclosed in U.S. Pat. No. 7,156,654, the entire disclosure of which is hereby incorporated by reference into this specification. Claim 2, e.g., of this patent, describes “2. The force adjusting mechanism according to claim 1, wherein the co-operating structures comprise a series of successive detent formations along an outer surface of the shaft and a component on the lock movable into and out of the detent formations on the shaft.”

Referring to FIG. 2, applicant's device also comprises “ . . . a component on the lock movable into and out of the detent formations . . . ,” viz., the end 46 of the metal tab 44.

The “successive detent formations” of U.S. Pat. No. 7,156,654 are described, e.g., at lines 1-17 of column 5 of such patent, wherein it is disclosed that: “By way of example, in an illustrative force adjusting mechanism, shaft 100 can be of 316 stainless steel, the diameter measured at end faces 104, 106 can be about 0.035 inch, the length measured between end faces 104 and 106 can be about 2.36 inches, the axial length of the central portion of shaft 100 containing detent formations 110 can be about 0.860 inch, each detent formation 110 can have an axial length of about 0.045 inch, the surface 114 can have an inner or minimum diameter of about 0.035 inch and an outer or maximum diameter of about 0.045 inch and ramp surface 114 can define an angle of about 7.1 degrees with respect to the shaft longitudinal axis 102, and each annular transition surface 116 can have an axial length of about 0.005 inch. The foregoing is by way of example, for purposes of illustration, and shaft 100 can be of other materials, cross-sectional shapes and dimensions and detent formations 110 can be of other shapes and dimensions.”

A similar “successive detent formation” is disclosed in FIGS. 2A and 3 of U.S. Pat. No. 5,884,367, the entire disclosure of which is hereby incorporated by reference into this specification. As is disclosed in this patent (see column 3), “With reference to the drawings and in particular to FIGS. 1, 2, 2A, the cable tie straps shown as a whole in 1 comprises a symmetrical head part 2, shaped as a hammer and a tail part 3 ending in a tail end 4. As it will be better shown in the following, both the head 2, and the tail 3 have a mirror-like symmetrical structure, thanks to which the very end of the tail 4 of the strap 1 may be inserted within the locking cavity 5 of the head 2 either on the right side or on the left side, as it is shown by the arrows F1, F2 in FIG. 2. The locking action of the tongue 3 within the head 2 is performed by effect of the positive locking by a symmetrical tooth or pawl 6 that cooperates with a double sawtooth toothing 7A, 7B realized on both the larger sides of the tail 3.”

Referring again to FIG. 1, and to the preferred embodiment depicted therein, it will be seen that ligature 26, once it is engaged with its locking device 16, may be moved in the direction of arrow 24 but not in the direction of arrow 28. Because it only locks in the downward (arrow 24) and not the upward (arrow 28) direction, it is said to be unilateral.

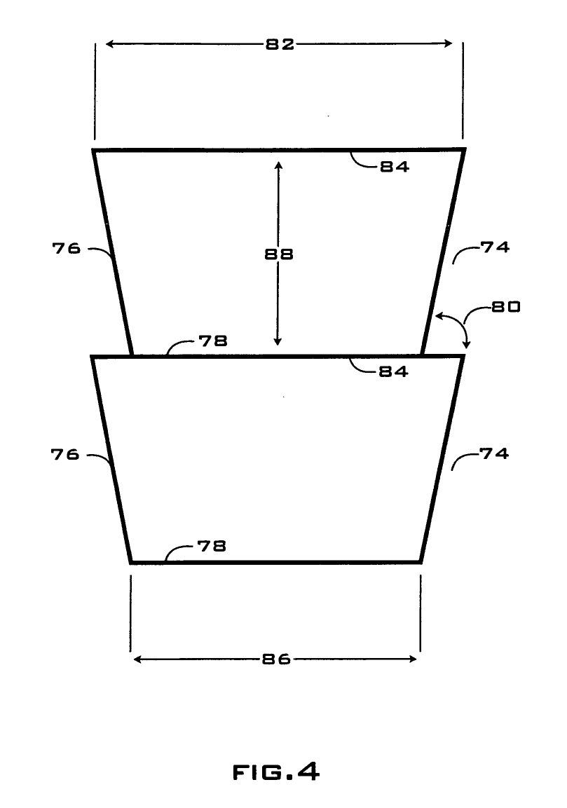

The ligature 26 is comprised of a locking portion 70 which, in turn, is comprised of a multiplicity of successive detents 74. A partial view of certain preferred successive detents 74 is illustrated in FIG. 4.

In the preferred embodiment depicted in FIG. 4, and in one aspect thereof, each of locking means 74 is comprised of a descending wall 76 and a base 78; the locking means 74 preferably is cylindrical and thus has only one such descending wall 76 and one such base 78. The descending wall(s) 26 preferably form an acute angle 80 with the base that ranges from about 70 to about 89 degrees.

In one preferred embodiment, ligature 26 is comprised of or consists essentially of biocompatible material. One may use the same biocompatible material for ligature 26 as is used for the locking mechanism 16.

The ligature 26 is not drawn to scale, and it does not necessarily represent the precise number of locking means 74 that preferably are present in the device. In one embodiment, ligature 26 is comprised of from about 50 to about 400 such locking means 74. In one aspect of this embodiment, ligature 26 is comprise of from about 20 to about 200 such locking means 74. In an even more preferred embodiment, ligature 26 is comprised from about 200 to about 400 such locking means 74.

FIG. 4 is a side view of two adjacent locking means 74, each of which are preferably cylindrical and, in combination, form a stepped structure. In the embodiment depicted, each of such locking means 74 has substantially the same dimensions. In another embodiment, not shown, each of such locking means 74 has different dimensions.

Referring to FIG. 4, it will be seen that each of locking means 74 has a maximum diameter 82 (i.e., the length of its top wall 84) and a minimum diameter 86.

The maximum diameter 82 preferably is less than about 3 millimeters, and more preferably is less than about 1.5 millimeter. In one embodiment, the maximum diameter 82 is from about 0.9 to about 1.8 millimeters.

Each of locking means 74 preferably has a height 88 of less than about 0.7 millimeters and, more preferably, less than about 0.3 millimeters. The ratio of the height 88 to the maximum diameter 82 preferably less than 1.0 and, more preferably, less than about 0.8. In one aspect, ratio is from about 0.4 to about 0.6. In another aspect of this embodiment, there are from 1 to about 10 locking means 74 for each distance of the ligature portion 70 that is equal to the maximum diameter 82 of the locking means 74.

Referring again to FIG. 3, and in the preferred embodiment depicted therein, it will be seen that the ligature 26 is comprised of a tapered tip 27 to facilitate insertion of the ligature 26 into the locking mechanism 16. The tapered tip 27 preferably has a length 90 of from about 3 to about 6 millimeters. By comparison, the ligature portion 70 preferably has a length 92 of from about 1 to 2 inches.

Referring again to FIG. 3, the ligature 26 is connected to an orthopedic onlay 72. Thereafter, the orthopedic onlay is cemented to the lower portion of a tooth by conventional means. Thus, e.g., one may use the process and apparatus of U.S. Pat. No. 3,835,538. Claim 11 of this patent, the entire disclosure of which is hereby incorporated by reference into this specification, describes: “The process of exerting corrective traction on an impacted tooth comprising a. exposing a small area of the lower portion of said impacted tooth; b. cementing to said exposed portion an orthodontic onlay having a base surface with openings leading from said surface toward the opposite surface and anchor means on said opposite surface for attaching a ligature thereto; and c. attaching a ligature to said anchor means and applying tension to said ligature whereby said impacted tooth is caused to move toward an erupted position.”

The orthopedic onlay 72 used in the process of the instant invention is preferably similar to the orthopedic onlay depicted in FIG. 2 of U.S. Pat. No. 3,835,538. In one embodiment, such orthopedic onlay is described by claim 1 of such patent, which discusses: “1. An orthodontic onlay adapted to be cemented to an impacted tooth to aid in exerting corrective traction thereon, comprising a curved base surface having a curvature essentially the same as that of a lower portion of such a tooth and having a lower edge of a configuration that conforms essentially to the profile of the lower edge of the tooth, a series of openings leading from said surface toward the opposite surface, for receiving and holding cement and thereby increasing the bond between the tooth and the onlay when cement is placed thereon and anchor means consisting of a single closed loop on said opposite surface for attaching a ligature thereto, whereby the anchor means may be attached to an exposed portion of an impacted tooth, a ligature may be attached to said loop and corrective forces applied to the impacted tooth.”

By way of further illustration, and in one preferred embodiment, the orthopedic onlay 72 used is a bondable traction hook identified as a “round traction hook” at page 147 of the TP Orthodontics Product Catalog (published by TP Orthodontics, Inc., 100 Center Plaza, LaPorte, Ind. 46350 in 2005). By way of further illustration, the orthopedic onlay used is similar to eruption appliance 17-000-10 depicted on page 132 of Catalog 12 published by GAC International, Inc., 355 Knickerbocker Avenue, Bohemia, N.Y. 11716.

As noted above, the orthopedic onlay 72 may be cemented to the tooth 12 by conventional means. Thus, and referring again to U.S. Pat. No. 3,835,538, “The shape of the onlay 15 having been determined, an important feature of the invention is its provision of means for enhancing adhesion. For one thing, the surface 16 may be plasma treated to give a surface portion 20, which enhances adhesion several times. The treatment may be done in a chamber or reactor operating at a few torr of pressure of a suitable circulating plasma gas, such as air, oxygen, nitrogen, or helium, with radio frequency energy applied. Oxygen or air is especially effective as a plasma gas to remove films of grease or oil or other organic residue, with the resulting oxidation products, such as carbon dioxide and water being removed. This may be followed by a helium plasma treatment, which is followed by a purge gas. For further information, reference is made to an article entitled “How to Obtain Strong Adhesive Bonds via Plasma Treatment” by Richard L. Bersin in Adhesives Age for March 1972. Such treatment can increase the bond strength of plastics in the order of ten times what it would be otherwise.”

U.S. Pat. No. 3,835,538 also discloses that: “Furthermore, the onlay may be pierced by through openings 21 (FIGS. 1 and 3) or by blind openings or recesses 22 (FIG. 1) and either of these may be either round, square, or any other shape, extending from the base surface 16 of the onlay 15. These openings 21 and 22 aid in the retention of cement 23 and to assist in obtaining a strong bonding force between the onlay 15 and the tooth 17. The openings 21 and 22 always communicate with the base side 16 of the onlay 15, whether they go all the way through or not. This is an important feature of the invention and it applies to other kinds of onlays 15 that are to be cemented to a tooth. It applies, for example, to onlays used in connection with tooth straightening for retaining arch wires.”

As is known to those skilled in the art, the back surface of the orthopedic only is generally comprised of a metal mesh pattern that furnishes a substantial amount of surface area and facilitates the physical and chemical bonding of cement to the onlay. Such adhesive joining may be effected by dental cement such as, e.g., the dental cements described in U.S. Pat. Nos. 3,962,267 (dental cement composition), 4,524,824 (dental cement), 4,647,600 (dental cement compositions), 5,151,453 (light curable ionomer dental cement), 6,133,339 (dental cement for temporary dental prosthesis or appliance), and the like. The entire disclosure of these United States patents is hereby incorporated by reference into this specification.

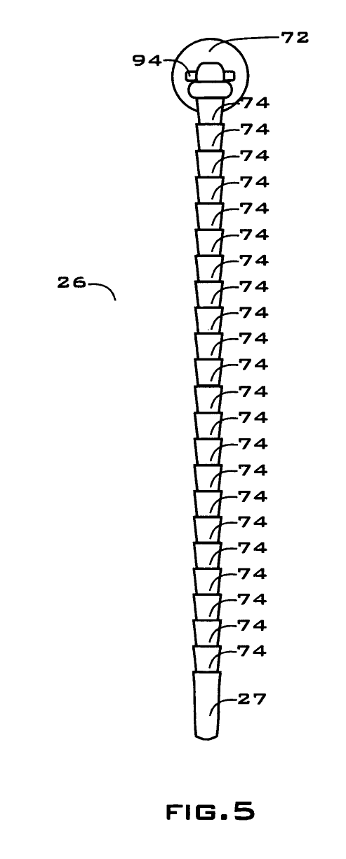

FIG. 5 is front view of a ligature 26 that has been tied to an orthopedic onlay 72. In the embodiment depicted, the orthopedic onlay 72 is comprised of an eyelet 46 through which the ligature 26 may be threaded. As is known to those skilled in the art, such an eyelet is but one means for attaching a ligature. Reference may be had, e.g., to Figure that depicts an eyelet incorporated into ligature 26.

Thus, e.g., U.S. Pat. No. 3,835,538 refers (in its claim 1) to “ . . . anchor means consisting of a single closed loop . . . ” At column 3 of this patent, it is disclosed that: “On the front side 18 of the onlay 15, the side which is opposite to the base surface 16, a suitable means for attachment of a ligature is provided. This may be a plastic loop 25 integral with the onlay 15, or it may comprise of a metal member . . . with two members 27 going through the onlay 15, each having a grommet or washer on their opposite side.” The entire disclosure of this patent is hereby incorporated by reference into this specification.

Thus, e.g., U.S. Pat. No. 5,292,249, discusses an “eyelet 82.” At column 4 of this patent, it is disclosed that “A bracket 80 . . . is conventionally secured to the misaligned tooth 12 and the filament 24 is tied to an eyelet 82 on the bracket 80 . . . . After an end of the filament 24 is tied to the eyelet 82 on the bracket 80, a key 71 . . . can be inserted into the key portion 68 of the shaft 20 . . . .”

Referring again to FIG. 5, and in the preferred embodiment depicted therein, it will be seen that ligature 26 is attached to eyelet 94 of orthopedic onlay 72. As is known to those skilled in the art, a ligature is a cord or thread used for tying two parts together.

By comparison, the orthopedic onlay 72 depicted in FIG. 3 is integrally connected to the ligature. In the embodiment depicted in such FIG. 3, the ligature and the orthopedic onlay are rigidly affixed so that no relative movement is allowed therebetween.

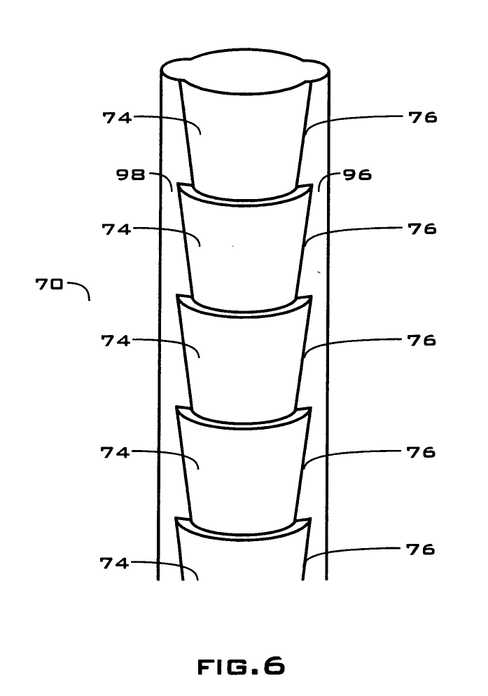

FIG. 6 is a partial perspective view of one preferred embodiment of intermediate portion 70 of ligature 26, illustrating rails 96 and 98 of such portion 70. These rails are also shown in FIG. 3.

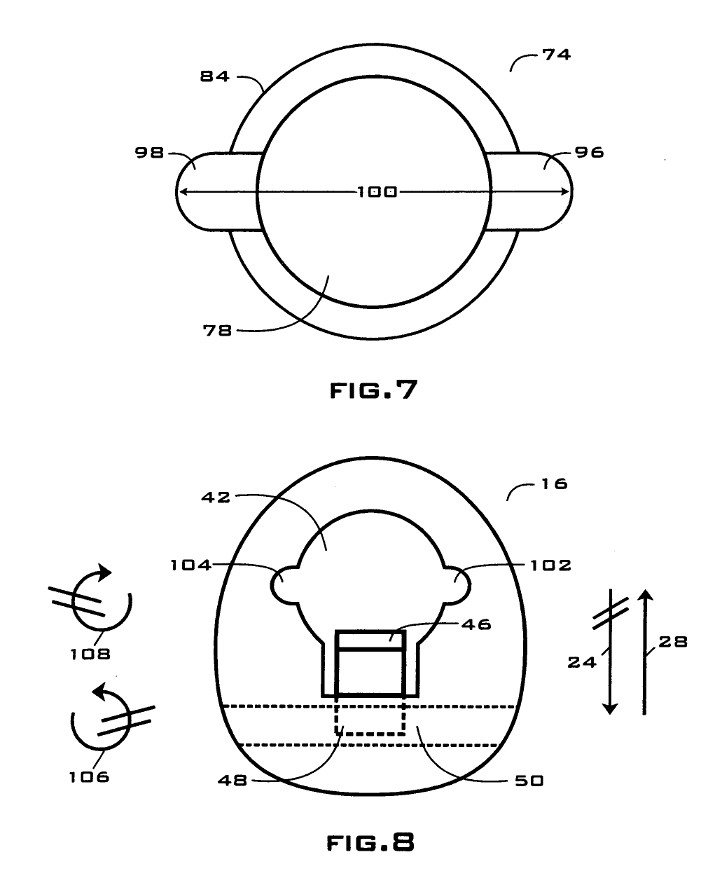

FIG. 7 is a bottom view of one of the sections 74, showing, e.g., bottom wall 78 of section 74 and, extending beyond said bottom wall 78, top wall 84 of such section 74. As is more clearly indicated in FIG. 6, whereas each of the sections 74 have inwardly descending walls (as viewed from top to bottom), the side rails 96 and 98 preferably have walls that have the same maximum dimension 100 throughout the length of portion 70 of ligature 26. As will be apparent, this ligature 26 is adapted to provide rotational locking within a suitable locking device 16.

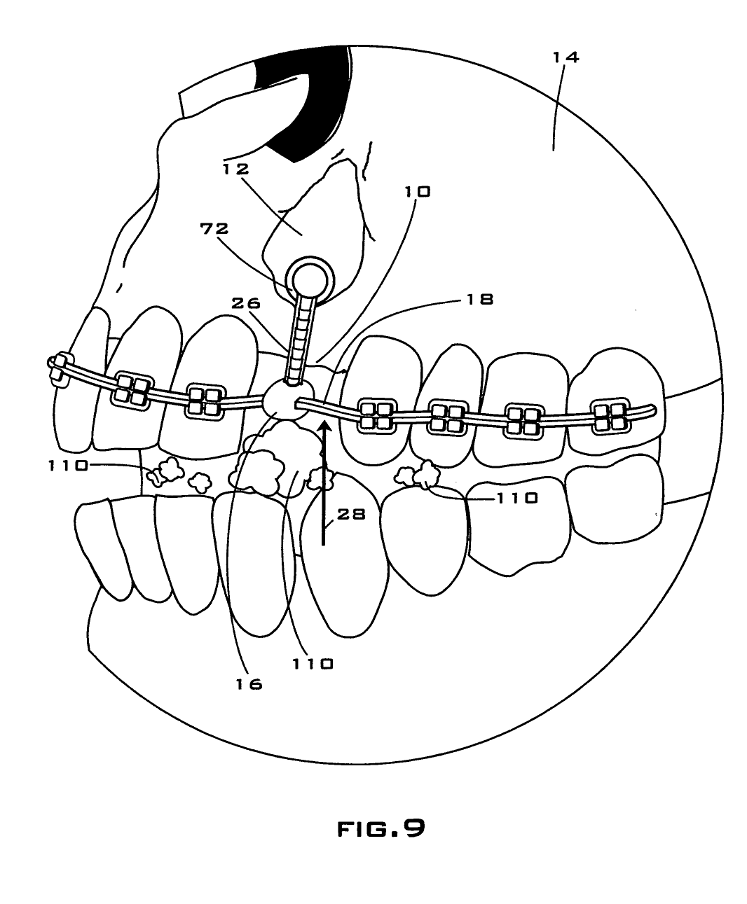

FIG. 8 is a schematic sectional view of suitable locking device 16 that has an interior cavity 42 that is adapted to receive the rails 96 and 98 (at rail receiver portions 102 and 104 thereof). As will be apparent, when the ligature 26 is so configured and is disposed in the receptacle 42, the ligature cannot be moved when force is applied in the direction of arrow, or in the direction of arrow 108, or in the direction of arrow 24. Only when force is applied in the direction of arrow 28 can there be relative movement between the ligature 26 and the locking device 16.

FIG. 9 is a schematic representation of the forces that act upon the device 10 when a patient is chewing food 110. As such chewing occurs, force is exerted upwardly on the locking device 16 in the direction of arrow 28. As such force is upwardly exerted, archwire flexes, and the locking device is pushed upwardly until it moves from one detent 74 to the next higher adjacent detent 74 (not shown in FIG. 1). In general, in chewing a force is applied to the lock that creates an upward pressure of from about 100 to about 400 grams that will be sufficient to move the locking device from one detent 74 to another. Thus, as desired, the device 10 is self adjusting in only one direction, direction 28.

Referring again to FIG. 1, when the ligature 26 initially extends beneath the bottom surface 29 of the locking device 16, it may be removed by cutting it off flush with such bottom surface. Furthermore, when chewing causes the ligature 26 to extend beneath such bottom surface 29, it also may be cut off periodically so as not to become irritating to the patient. One may, e.g., use nail clippers to remove such excess.

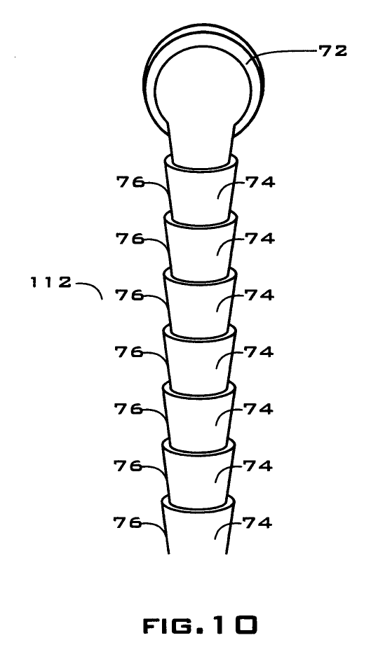

FIG. 10 is a schematic view of a ligature 112 that does not contain rails 96 and/or 98 and, consequently, does not effect the rotation of a misaligned tooth when such tooth is moved towards the locking mechanism 16.

As will be apparent to those skilled in the art, and with at least one of the preferred embodiments described herein, adjustment is simplified because there is no need to continually tension, or otherwise tie and untie a chain or elastic to an archwire. Instead, the archwire is used to hold a locking device that is capable of only allowing a ligature's unilateral movement. The ligature, although only about 1 millimeter at its maximum diameter (in one embodiment), is rigid enough to maintain its relative path extending from the traction hook when a force is applied to the archwire in the direction of the impacted tooth. This adjustment often occurs during chewing but can be performed by a patient or doctor if necessary. The mechanical response of the lock allows a slight incremental movement that decreases the overall distance between the lock and the tooth. This is due in part to the short-term immobility of the impacted tooth. With the increased torque now applied by the archwire on the tooth through the lock and ligature system, the tooth is mobilized over time. The archwire actively applies pressure to the tooth until it reaches its resting position. This process will occur many times to move the tooth into proper alignment within the arch form.

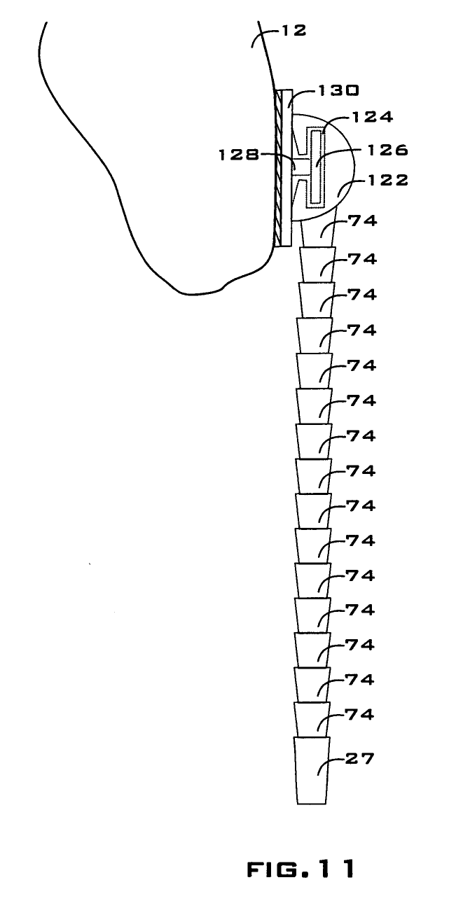

FIG. 11 is a schematic view of another assembly 120 that is comprised of a multiplicity of successive detents 74 integrally connected to a head 122. Head 122 is comprised of a cavity 124 within which bondable button 126 is movably disposed; and bondable button 126 is connected by shaft 128 to base surface 130. Base surface 130 is attached by cement 132 to the tooth 12.

As will be apparent, the assembly 120 allows the ligature device to be disposed at different angles vis-a-vis the locking assembly 16 inasmuch as it allows free rotation of the head 122 along the axis of the button 126.

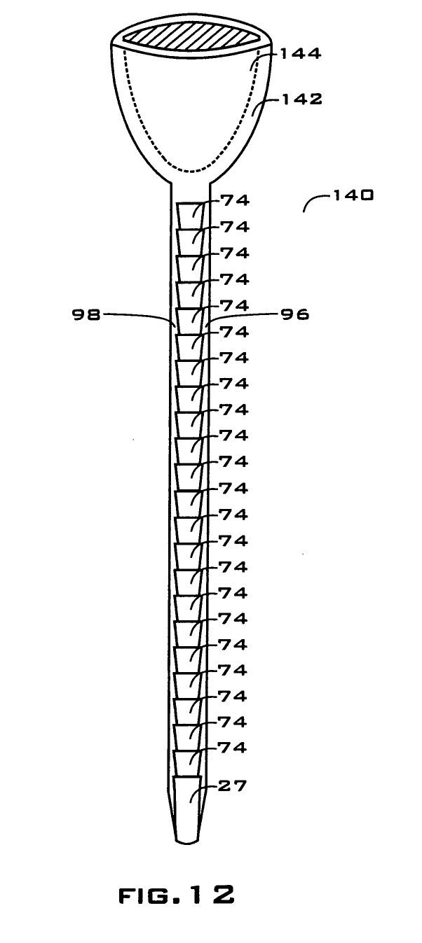

FIG. 12 is a schematic view of an assembly 140 whose onlay 142 is comprised of a cavity 144 that is adapted to receive the bottom portion (not shown) of tooth 12. By comparison, in the embodiments depicted in FIG. 1, the onlay is cemented to a front surface of the tooth 12.

In FIG. 1 a multiplicity of brackets 20 are shown connected to teeth 22. As is known to those skilled in the art, a bracket is an orthopedic onlay through which is disposed an archwire. Reference may be had to U.S. Pat. Nos. 4,634,662 (orthodontic bracket having archwire seating and locking mechanism), 4,712,999 (convertible, self-ligating archwire positioning orthodontic bracket), 5,174,754 (self-ligating, self-locking dental bracket with T-shaped archwire slot), 5,358,402 (ceramic orthodontic bracket with archwire slot liner), 5,618,176 (orthodontic bracket and ligature and method of ligating archwire to bracket), 5,630,715 (orthodontic bracket with an engagement mechanism for retaining an archwire), 6,478,579 (orthodontic twin bracket with archwire floor and side wall relief), and the like. The entire disclosure of each of these United States patents is hereby incorporated by reference into this specification.

I claim:

1. A self-adjusting apparatus for moving an impacted tooth, wherein said apparatus is comprised of a locking mechanism, an archwire disposed within said locking mechanism, and a ligature movably connected to said locking mechanism.

2. The self-adjusting apparatus as recited in claim 1, wherein said apparatus further comprises a multiplicity of brackets that are connected to said archwire.

3. The self-adjusting apparatus as recited in claim 2, wherein said archwire is disposed within said multiplicity of brackets.

4. The self-adjusting apparatus as recited in claim 1, wherein said locking mechanism is comprised of means for allowing movement of said ligature within said locking mechanism in a first direction.

5. The self-adjusting apparatus as recited in claim 4, wherein said locking mechanism is comprised of means for preventing movement of said ligature in a second direction, wherein said second direction is opposite to said first direction.

6. The self-adjusting apparatus as recited in claim 5, wherein said apparatus is comprised of means for preventing the rotation of said ligature within said locking mechanism.

7. The self-adjusting apparatus as recited in claim 6, wherein said locking mechanism is comprised of a first orifice within which archwire is disposed.

8. The self-adjusting apparatus as recited in claim 7, wherein said orifice has a substantially rectilinear cross-sectional shape.

9. The self-adjusting apparatus as recited in claim 7, wherein said locking mechanism is comprised of a second orifice within said ligature is disposed.

10. The self-adjusting apparatus as recited in claim 9, wherein said locking mechanism is comprised of a flexible tab that extends into said second orifice.

11. The self-adjusting apparatus as recited in claim 10, wherein said ligature is comprised of at least about 50 successive detent structures each of which is comprised a top wall, a bottom wall, and side wall descending from said top wall to said bottom wall.

12. The self-adjusting apparatus as recited in claim 11, wherein each of said successive detent structures has a substantially conical shape.

13. The self-adjusting apparatus as recited in claim 12, wherein said ligature is comprised of from about 50 to about 400 of said successive detent structures.

14. The self-adjusting apparatus as recited in claim 13, wherein each of said successive detent structures have substantially the same shape and the same dimensions.

15. The self-adjusting apparatus as recited in claim 13, wherein said ligature is comprised of a tapered tip.

16. The self-adjusting apparatus as recited in claim 13, wherein said apparatus is comprised of an orthopedic onlay, and wherein said orthopedic onlay is connected to said ligature.

17. The self-adjusting apparatus as recited in claim 16, wherein said orthopedic onlay is comprised of an eyelet, and wherein said ligature is disposed within said eyelet.

18. The self-adjusting apparatus as recited in claim 16, wherein said ligature is comprised of a first rail.

19. The self-adjusting mechanism as recited in claim 18, wherein said ligature is comprised a second rail.

20. The self-adjusting mechanism as recited in claim 19, wherein said locking mechanism is comprised of a first slot and a second slot, wherein said first rail is disposed within said first slot, and wherein said second rail is disposed within said second slot.
